(19) United States
(12) Patent Application Publication
(10) Pub. No.: US 2006/0165458 A1
(43) Pub. Date: Jul. 27, 2006

(54) Method and system for printing a document

(75) Inventors: Joop Gortemaker, Huizen (NL); Gerhard Hidding, Heerenveen (NL)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Dutch Document Company B.V., Huizen (NL)

(21) Appl. No.: 11/321,708

(22) Filed: Dec. 29, 2005

(30) Foreign Application Priority Data
Dec. 31, 2004 (NL) NL 1027930

(51) Int. Cl. B41J 5/30

(52) U.S. Cl. 400/62

(57) ABSTRACT

A method includes printing at least one document provided with information content and with at least one mark on a printing unit. A first print instruction comprising the information content to be printed on the document is provided from a document generator. A marking module generates a second print instruction for printing at least one mark on the document. The generation and processing of the second print instruction for printing the mark takes place independently of the information content of the first print instruction.

### BACKGROUND OF THE INVENTION

The discussion below is merely provided for general background information and is not intended to be used as an aid in determining the scope of the claimed subject matter.

An aspect of the invention relates to a method for printing a document provided with information content and at least one mark.

To handle relatively large-scale postal traffic, use is made of enveloping machines, by means of which documents such as bank statements, invoices, mailings etc. are put in envelopes. The documents are frequently different for every addressee, e.g. as regards to the number of sheets a document comprises. Errors may occur during the printing of the documents, such as the unintended addition of an extra, empty sheet or the leaving behind of a printed sheet in the printing unit. Furthermore, human errors frequently occur during the restacking of the documents prior to the enveloping thereof. It stands to reason that incorrect collation of documents, for example in that sheets are missing and/or that the wrong sheets are enclosed in the envelope to a particular addressee, is undesirable.

Several measures for checking the enveloping process are known in the prior art, which measures are aimed at preventing or indicating the occurrence of undesirable events.

Dutch patent NL 1000867 discloses a device and a method wherein verification data are determined on the basis of sets of print instructions, which data are compared with scanning results. The scanning results are obtained by scanning a passing document on its way to the enveloping machine, which is done by means of a scanning unit that is connected to the enveloping machine. If the comparison between the verification data and the scanning result for a particular sheet exceeds a predetermined threshold value, a difference report signal is generated.

US 2003/0084068 discloses a method and a system for reformatting a file and adding control indicia to the file for use in a document finishing system. Information is to that end extracted from the print instructions for the purpose of determining appropriate codes, which are printed on the document for use in the document finishing process. In this regard use is made of the fact that documents frequently have comparable information content, such as a letter heading, a part having a variable content, a total balance amount, a customer number or an address of the addressee.

A drawback of the prior art according to US 2003/0084068 as described above is that the provision of the marks on the basis of the information content of the document is not very flexible as far as document changes are concerned, and that in many cases tailor-made adaptations are required. Mainly because of this drawback, users of enveloping machines frequently appear to be unable to print the verification marks relating to the enveloping process on the documents.

### SUMMARY OF THE INVENTION

This Summary and Abstract are provided to introduce some concepts in a simplified form that are further described below in the Detailed Description. This Summary and Abstract are not intended to identify key features or essential features of the claimed subject matter, nor are they intended to be used as an aid in determining the scope of the claimed subject matter. In addition, the description herein provided and the claimed subject matter should not be interpreted as being directed to addressing any of the short-comings discussed in the Background.

An aspect of the invention is a method for printing at least one document provided with information content and at least one mark on a printing unit. The method includes receiving at least a first print instruction comprising the information content to be printed on the document from a document generator; generating at least a second print instruction for printing said at least one mark on the document; and processing the first and the second print instruction for printing the information content and the mark on the document, wherein generating and processing of the second print instruction for printing said at least one mark takes place independently of the information content of the first print instruction.

The method makes it possible to provide a document or documents that are printed from the first printed instruction with a mark, a code or a finishing instruction independently of the manner in which the document itself has been created. The marking module independently adds a mark without looking at the information content of the document, such as the letter heading, the customer number or the address of the addressee, and thus provides flexibility, because it is not necessary to take the location or the format of the aforesaid information content into account. In addition to that, this functionality is added through the simple installation of a marking module, so that users of enveloping machines will no longer have difficulty providing their documents with marks in advance. The marking module to that end makes use of functionality that is e.g. incorporated in a standard or typical printing unit.

It will be understood that the first and the second print instructions may form part of a single file that is being processed by the printing unit for printing both the information content and the mark.

It is further noted that the printing of a document is to be understood to include also the printing of a document to a file, the content of which file is to be printed on paper on a printing unit at a later point in time.

It is further noted that said mark may be arranged for follow-up treatment of the document, e.g. in a mail collation device.

The marks that are independent of the information content can be an arranged series of marks, for example, which may continue from one document to the other for the purpose of monitoring the correct sequence of the documents, or sheets thereof, during the enveloping process. The marks provide a completeness check by monitoring whether document sheets are presented to the enveloping machine in the correct sequence. This makes it possible to prevent the wrong documents or the wrong combination of sheets being put in an envelope. It will be apparent to those skilled in the art that said marks are not the same as conventional page numbers of documents, as said page numbers are not consecutive numbers, with the numbering starting anew with each document. Such a numbering method does not provide a completeness check. The marks can comprise numerical marks, i.e. marks that indicate a sequence, such as serial numbers, but they may also comprise other marks that are capable of being arranged in a sequence. Said marks can be represented in a bar code, a bit code or other type of code.

Another example is the use of feeding stations or sheet trays for different sheets, with the mark to be printed being dependent on the feeding station from which a sheet or a preceding sheet or a next sheet is to be obtained upon printing. In this way a user can very easily indicate the beginning and/or the end of a document (a set of sheets), for example by obtaining a first sheet of a document, on which a first mark is printed, from a first feeding station, and obtaining trailer sheets, on which second marks are printed, from a second feeding station. This makes it possible to handle documents comprising varying numbers of sheets indiscriminately. To that end a reading station connected to the enveloping machine can determine the beginning and/or the end of a set of sheets on the basis of said first and/or second marks.

The two types of marks from the above examples can be advantageously combined. Other marks may be used as well. In the special case in which documents consist of a fixed number of sheets, a counter in an enveloping machine can be used for determining the end of a document or the beginning of a new document on the basis of the sequence information. For example, when the first sheet or the last sheet of a document is obtained from a different feeding station than (any) trailer sheets or preceding sheets, the first sheet or the last sheet may be provided with pre-printed marks for distinguishing between documents.

Advantageous embodiments of the invention as a method are further defined in the claims.

Further aspects of the invention relate to a printing unit, a system and a marking module as defined in the claims.

It is noted that the method, the printing unit, the system and the marking module can also be used for purposes other than documents for enveloping postal items. Think in this connection of providing stickers (another form of a document) with marks, for example, which stickers can subsequently be affixed to products, so that the follow-up treatment of the sticker will automatically involve the follow-up treatment of the products, for example the selection thereof in a logistic process. The document also may be a personalised newspaper or a personalised magazine, for example, in which case separate sheets are provided with a mark that is used for collating newspapers or magazines not having the same information content.

### BRIEF DESCRIPTION OF THE DRAWINGS

Aspects of the invention will now be explained in more detail with reference to the appended figures, which show exemplary embodiments. It will be understood that the invention is by no means limited to these exemplary embodiments.

In the figures:

FIG. 1 is a schematic representation of an arrangement for enveloping documents;

FIGS. 2A-2C show three possible systems for printing documents according to an exemplary embodiment of the invention;

FIG. 3 is a step diagram illustrating part of the method according to one embodiment of the invention;

FIGS. 4A and 4B show an example of a document provided with marks provided in accordance with an embodiment of the invention;

FIG. 5 shows a system for printing documents according to another embodiment of the invention; and

FIGS. 6A-6C show an example of a document provided with marks provided by means of the system that is shown in FIG. 5.

### DETAILED DESCRIPTION OF THE ILLUSTRATIVE EMBODIMENT

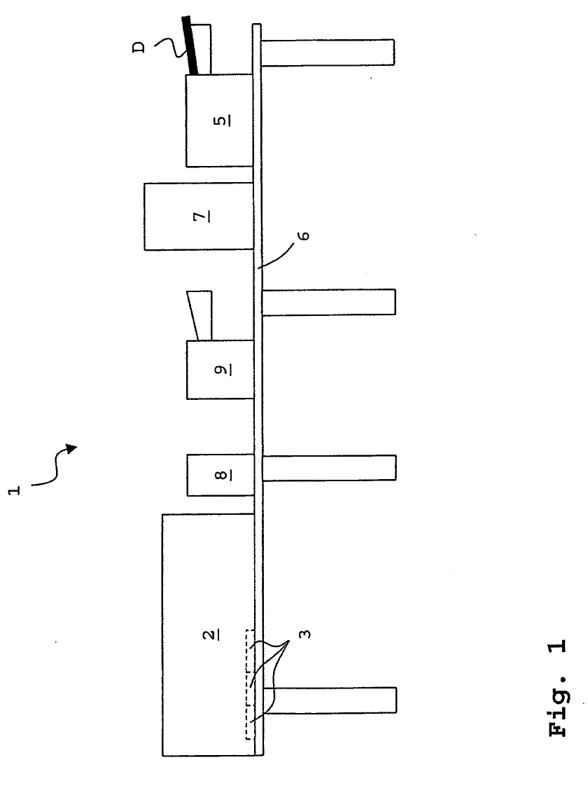

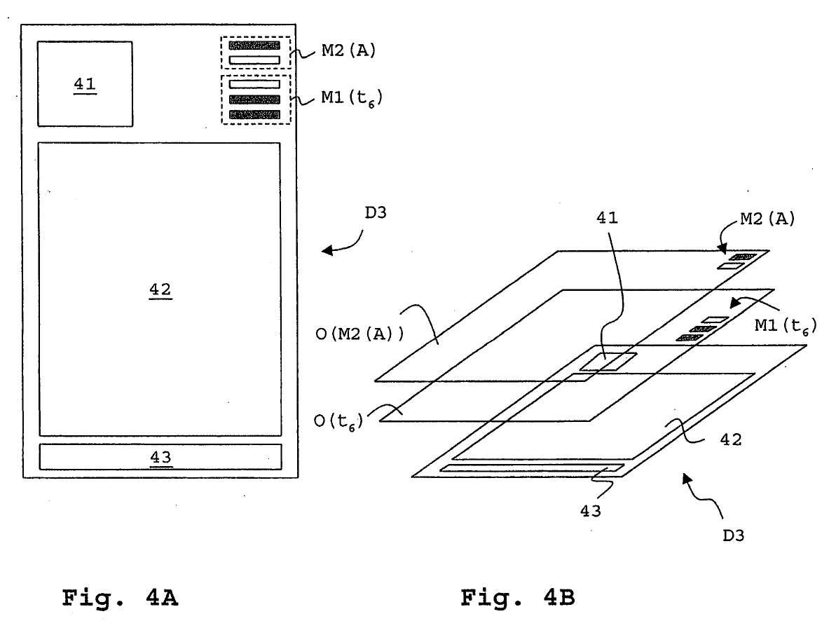

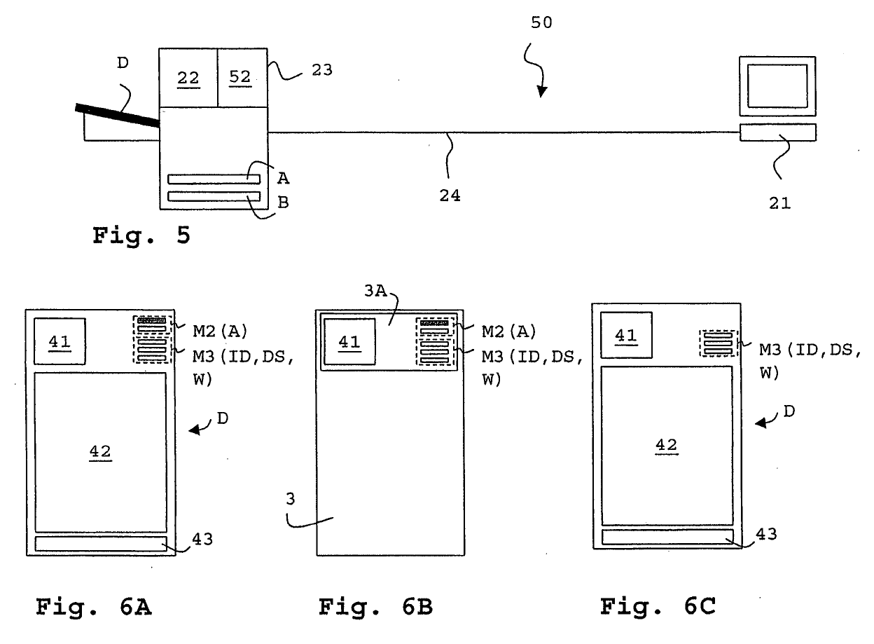

FIG. 1 shows an arrangement of a mail collation device 1, comprising an enveloping machine 2 with envelopes 3. Documents D, comprising various sets of sheets, are presented at a feeding station 5 on a conveyor belt 6. At least one mark e.g. any one or more of marks M1, M2 (see FIGS. 4A and 4B), M3 (see FIGS. 6A-6C) present on a sheet of a document D is read, e.g. a process which is frequently referred to as OMR (optical mark recognition), by a reading station 7 for verifying whether the documents D have been correctly collated before the document is enveloped and transported onwards to a folding station 8. Appendices may be added via an appendix station 9. In the machine 2, every document D, possibly provided with an appendix, is supplied to an open envelope 3 ready to receive the document. An example of such an arrangement 1 is the system SI92 of Neopost. Also other, smaller-scale enveloping systems are known, such as Neopost's SI72.

An aspect of the invention relates to the provision of including at least one of the marks M1, M2, M3 on the documents D before they are read at the reading station 7 in the arrangement 1.

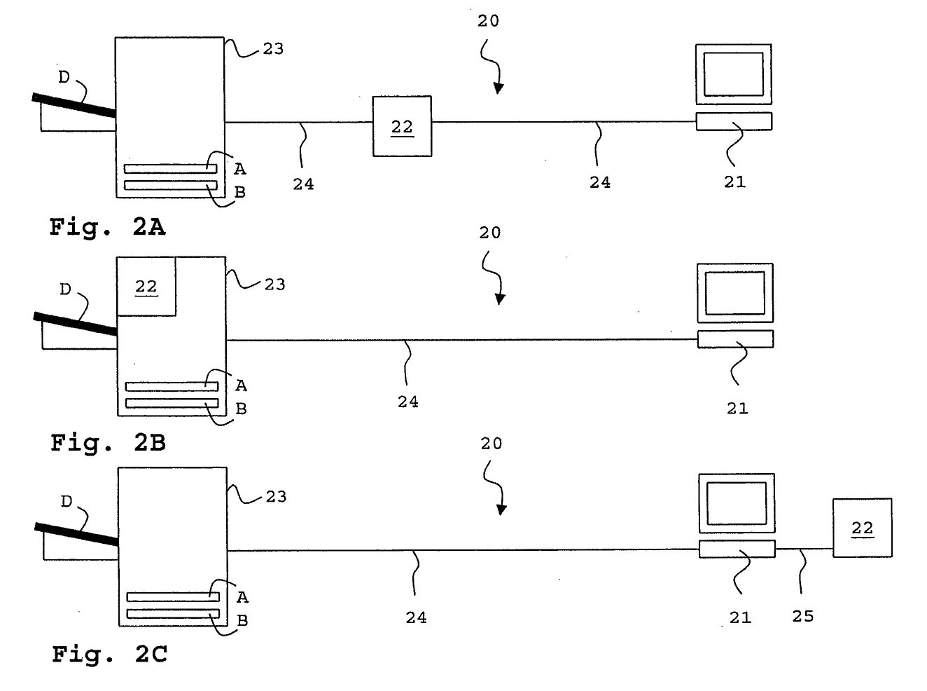

FIGS. 2A-2C schematically show three variants of a system 20 comprising a document generator 21, a marking module 22 and a printing unit 23, which are communicatively connected or arranged. The document generator 21 may comprise a simple personal computer, for example. The printing unit 23 can comprise a Hewlett-Packard printer, for example. The printing unit 23 has one or more of feeding stations or sheet trays A and B for sheets of the documents D and an output tray for the documents D.

As is shown in FIG. 2A, the marking module 22 may comprise a separate unit arranged between, or connected to the connection 24 between, the document generator 21 and the printing unit 23.

The marking module 22 may form part of or be connected to the printing unit 23, for example as a plug-in card provided with software, or otherwise adapted to work with, for carrying out the method according to the invention. This is shown in FIG. 2B.

The marking module 22 may also be integrated with the document generator 21, for example via a communication link 25 with the document generator 21, as shown in FIG. 2C, or in the form of software capable of running on or being executed by the document generator 21.

The function(s) of the marking module 22 may also be distributed over the aforesaid components or other components of the system 20. The communication between the document generator 21, the marking module 22 and the printing unit 23 can take place via a network, which may be a wired or wireless network.

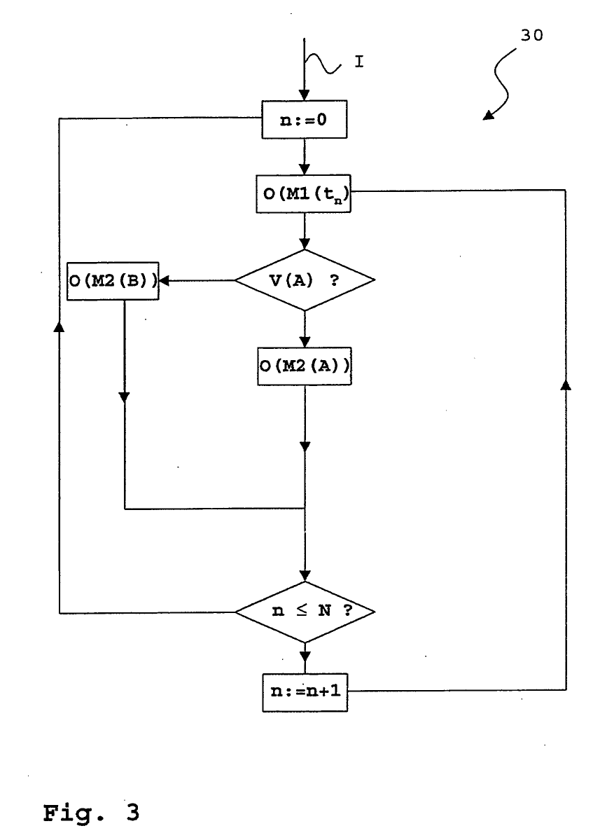

FIG. 3 is a flow diagram illustrating part of the method according to the invention. FIGS. 4A and 4B show a document that has been printed by using a method according to an aspect of the invention. The user of the system 20 has filled the sheet tray A with first sheets for the documents D, which can be provided with a logo of the user of the system 20. The sheet tray B is filled with trailer sheets for the documents D.

A first print instruction I (FIG. 3) is provided from the document generator 21, which instruction comprises the information content to be printed on, for example, documents D1, D2 and D3. The information content may comprise, among other things: a letter heading 41, a text portion 42 and a foot portion 43. This information content has been generated by a user of the document generator 21, for example by means of Microsoft Word, and has been formatted in accordance with the user's wishes. Part of the information content, for example the foot portion 43, may be pre-printed on one or more of the sheets of the documents D1, D2 and D3. When the first print instruction I is sent to the printing unit 23, the marking module 22 generates a second print instruction. The first print instruction I is typically stored in a buffer (not shown). The marking module 22 can be transparent to the first print instruction, i.e. the marking module leaves the first print instruction unchanged. The first print instruction and the second print instruction, or parts thereof, may also be combined into one print instruction for the printing unit 23, for example, or be processed sequentially by the printing unit 23.

The second print instruction O(tₙ) comprises a mark M1(tₙ) comprising sequence information, in this example a serial number tₙ, in the form of a binary overlay O(tₙ). Accordingly, a mark M1(tₙ) comprising sequence information is printed at the printing unit 23 simultaneously with but independently of the printing of the information content 41, 42, 43 on the relevant sheet of document D.

Once the mark M1 to be printed has been determined, it is subsequently determined on the basis of an auxiliary signal in step <V(A)?> from which sheet tray A, B of the printing unit 23 a sheet of a document D will be obtained. The auxiliary signal may have been sent to the printing unit 23 along with the first print instruction I or otherwise be known to the printing unit 23. The printing unit 23 may comprise only one sheet tray, whilst a distinction is nevertheless made between the first sheets and trailer sheets from one and the same sheet tray for every document D on the basis of a virtual auxiliary signal.

When a sheet of document D is taken from the (virtual) sheet tray A, a second print instruction O(A), comprising a mark M2(A) in the form of, for example, an overlay O(M2(A)) can be generated by the marking module 22. When a sheet is not taken from the sheet tray A, in this case from the sheet tray B, therefore, a second print instruction O(B) comprising a mark M2(B) in the form of, for example, an overlay O(M2(B)) can be generated. Consequently, a mark M2 indicating whether a sheet of a document D is a first sheet or a trailer sheet or a last sheet or a preceding sheet of document D can be provided simultaneously with the provision of the information content 41, 42, 43, albeit independently thereof.

Subsequently, it is determined in step <n N ?> whether the counter n needs to be reset. After all, when the number of sheets of the documents D is larger than the number of different first marks M1, a further sheet will be provided with a mark that has already been provided before. According to one embodiment of the invention, 2-5 bits, for example 3 bits, can be used for a bit code. A 3-bit code will provide sufficient security as regards to the sheet sequence. If the maximum number of bits is not exceeded, the counter n will be augmented and the process according to the flow diagram 30 will be gone through again.

It is noted that an aspect of the invention also relates to the provision of either the first mark M1, comprising a continuous series of sequence information, or the second mark M2, comprising the “first sheet” or “trailer sheet” indication by means of a sheet tray selection. It is further noted that the second mark M2 may also be printed on the sheets in advance, so that the functionality as described above can be obtained without using the auxiliary signal when the first sheet or the last sheet of a document D is obtained from the sheet tray A of the printing unit 23 at all times. It will further be understood that the printing unit 23 may also comprise more than two sheet trays A, B, (or for that matter more than one printer each having one or more trays can be used) and that the second mark M2 can be rendered suitable for further use. For larger series of documents D, the printing unit 23 may comprise four sheet trays A, B, C, D, for example, with trays A and B containing “first sheets” and trays C and D containing “trailer sheets”, for example. In that case the switch at the printing unit 23, e.g. from sheet tray A to sheet tray B, for example when the sheet tray A is empty, will have no consequences for the mark M2(A) to be printed. This mark M2(A) will also be printed on “first sheets” from the sheet tray B in that case.

It should be noted that, of course, the sheets in question may also be separate “last sheets” from a separate sheet tray A instead of separate “first sheets” from a separate sheet tray A. The last sheet of a document D will be provided with a mark M2(A) in that case, and the “preceding sheets”, i.e. the sheets preceding the last sheet of each document, will be provided with a mark M2(B). It should furthermore be noted that the system 1 may be set to recognise the “first sheet” of a document D or a “last sheet” of a document D.

The above-described embodiment of the invention and the example to be described below are based on a situation in which the “first sheet” of each document D is provided with a mark M2(A) different from that on the trailer sheets, whilst assuming that the system 1 is suitable for enveloping said documents D in an appropriate manner. A comparable situation occurs when the “last sheet” is taken from a separate (virtual) sheet tray A for the documents D (and is therefore provided with a mark M2(A) different from that on the preceding sheets), and the enveloping system 1 is set to recognise such last sheets for determining the end of a set of sheets for a document D.

The situation becomes more complicated when the converting system 1 is arranged for recognising a set of sheets on the basis of the recognition of the “first sheet” or the “last sheet”, whilst the “last sheet” respectively the “first sheet” of the documents D is obtained from the separate (virtual) sheet tray A. The fact is that in that case the “last sheet” respectively the “first sheet” would be provided with a deviating mark M2(A) if no additional measures were taken, which would lead to errors in the enveloping process. A solution according to an embodiment of the invention would be to move the deviating mark M2(A) to a “next sheet” respectively “a preceding sheet”, e.g. by supplying a moving signal to the marking module 22 and, if necessary, buffering a sheet to be printed. The deviating mark M2(A) will be printed on the “first sheet” or the “last sheet” of each document D in that case, thereby making it possible for the enveloping process to be suitably carried out. The first sheet of the first document can be recognised by the fact that this sheet is the first sheet of the first print instruction. The last sheet of the last document can be recognised by the fact that no further information is supplied any more, which can e.g. be determined via a “time-out” signal.

By way of an example, a first print instruction I is taken, in accordance with which three documents D1, D2 and D3 comprising 1, 5 and 3 sheets, respectively, are printed, which documents D1, D2 and D3 undergo a follow-up treatment in the mail collation device 1 in that said documents D1, D2 and D3 are placed into three different envelopes 3. FIGS. 4A and 4B show the first sheet of the third document D3. The sequence information is represented by a 3-bit code. It will be understood that in practice generally larger numbers of documents D will be concerned and that the present example is merely given by way of illustration of a method according to the present embodiment.

Sheet 1 of D1 is given a 0 in bit code as the mark M1(tₙ); sheets 1, 2, 3, 4 and 5 of D2 are given: 1, 2, 3, 4 and 5 and sheets 1, 2 and 3 of D3 are given 6, 7 and 0. Thus the sequence information from the first document D1 to the second document D2 and from the second document D2 to the third document D3 is printed as a series of consecutive numbers on the sheets of the documents D1, D2 and D3. The 3-bit code implies that both the last sheet of document D3 and the first sheet of D1 are given a 0 as the mark M1(tₙ).

Likewise, the sheets 0, 1 and 6 of documents D1, D2 and D3, respectively, being first sheets of the document obtained from sheet tray A of the printing unit 23, are given an A in bit code. The sheets 2, 3, 4, 5, 7 and 7 (of D3), being trailer sheets obtained from sheet tray B, are given a B as the mark M2.

The Table shows a schematic survey of the marks M1, M2 provided on the documents D1, D2 and D3 in bit code.

| Document | D1 | D2 | D3 |
|---|---|---|---|
| Sheet | 1 | 1 | 1 |
| | | 2 | 2 |
| | | 3 | 3 |
| | | 4 | |
| | | 5 | |
| M2 | A | A | A |
| | | B | B |
| | | B | B |
| | | B | |
| | | B | |
| M1 (tₙ) | 0 | 1 | 6 |
| | | 2 | 7 |
| | | 3 | 0 |
| | | 4 | |
| | | 5 | |

The marks M1, M2 are printed on the documents D1, D2 and D3 by the printing unit 23 together with, but independently of, the information content 41, 42, 43. The OMR reading station 7 from the arrangement 1 can subsequently use the marks M1, M2 for checking the enveloping process in a manner that is known per se. It should be noted printing of marks may not be seen or may be difficult to be seen by the user, but in contrast, can be seen by processing equipment such as reading station 7.

The follow-up treatment of a document D may also relate to the further logistic handling of document D, whether or not in combination with the above-described subsequent treatment of enveloping.

When it can somehow be determined which is the first page of a document D, for example by using the selection of sheets from the sheet tray A, B as described above, this first page may also be provided with a further mark M3 for providing information, for example logistic information. This embodiment will now be described with reference to FIG. 5, which shows a system 50 for printing documents provided with further marks, and with reference to FIGS. 6A-6C, which show sheets that have been printed by means of the system 50.

In the description below it is assumed that a separate logistic information module 52 is used in the printing unit 23 for providing said further mark M3. It will be apparent to those skilled in the art, however, that it is also possible to realise such functionality in a different manner, for example as part of software being run on the document generator 21 or the printing unit 23 (see FIG. 5) or as part of the marking module 22.

It should be noted that the functionality and the system 50 as described below can also be used independently of the use of the marks M1, M2 as described above.

The functionality as described below is in particular suitable for use as an alternative method and system for franking documents for postal delivery. In addition to that, aspects of the invention can also be used for tracing documents.

When a document is mailed, one or more of the following data may be known: the consignor of document D, the date of consignment, the franking value, the distributor of document D and the required service degree for document D. These data are usually fixed data for a specific set of documents D.

In this case the term consignor of the document can be understood to mean the person or organisation that pays the costs of the consignment of document D.

As a result of the increasing liberalisation of the postal market, it is no longer obvious who will take care of the distribution of the document.

The service degree for the shipment of a particular document may relate to specific circumstances that are relevant for the document, such as express mail, printed matter, traceability (see below).

The logistic information module 52 as shown in FIG. 5 may e.g. be arranged for providing one or more further marks M3. The mark M3 may e.g. represent an identification code ID for the consignor, a serial number DS of document D and/or a code W indicating the number of pages and or the weight class of the document. Said sign(s) M3 (ID), M3 (DS), M3(W) may be included in a second print instruction O(ID), O(DS) or O(w) for being printed on the first sheet of a document D.

The codes ID and W may also be input at the logistic information module 52 in advance, before the documents D are printed on the printing unit 23.

The code DS is a serial number that is consecutive from the first document to the second document, etc. Unlike the above-described mark M1, which is provided on every sheet of a document D, the code DS is a serial number that is consecutive from document to document and which is provided only on the first sheet of every document.

The system 50 operates as follows. A first print instruction I comprising the information content for one or more documents D is sent to the printing unit 23 from a document generator 21. Each document D comprises a particular number of sheets.

The logistic information module 52 prints the identification code ID of the consignor of the document D on every first sheet. In addition to that, a consecutive serial number DS can be printed on every first sheet, and also the code W (see FIGS. 6A). It will be apparent to those skilled in the art that the amount of information to be represented may be too large for a 1-dimensional bar code, and that the information can be more suitably represented in the form of a 2-dimensional bar code or other type of code or sign.

Mark M3, comprising the codes ID, DS and W, can be printed in such a manner that the codes will be at least readable and may be visible through the window 3A of the envelope 3.

The first sheet on which the codes ID, DS and W are printed can be determined on the basis of the selection of the sheet tray A, B from which a sheet is being obtained, so that the code M2(A) is shown on the first sheet as well, as already described above.

It is also possible to determine the first sheet in a different manner, however, whether or not visualised by a mark on said first sheet. Furthermore, the first sheet may be determined on the basis of the selection of the sheet tray A as described above, without the mark M2(A) actually being printed, however (see FIG. 6C).

When the codes ID and W are printed on the first sheet of document D, it becomes possible to use an alternative franking method, which does not require the use of a conventional franking machine. Said franking takes place independently of the information content 41, 42, 43 of the document D.

The code ID represents the person or organisation that pays for the consignment of the document D. Code W indicates the weight/the number of sheets of the documents, so that a franking price can be determined or verified together with the desired service degree.

The information module 52 can also print the code DS on the first sheet of the document D. The code DS, which is consecutive from document to document, can be used as verification to prevent franking fraud.

When more than one consignor of documents D make use of an information module 52, there is a chance that documents D will have identical codes DS. The combination of the codes ID and DS is a unique combination, however, which can be used for identifying a document D or for retrieving the status of the document. For example, the consignor or distributor of the document D may offer a service, e.g. on the Internet, whereby the consignment status of the document D can be retrieved by inputting the codes ID and DS or one or more derivatives thereof. Such a possibility already exists for parcel post, but so far a method as proposed herein has not been economically feasible for letter post.

Furthermore, marks M3 relating to the organisation that takes care of the distribution of the document D and/or to the desired service level can be printed via the second print instruction O.

It will be understood that the mark M3 may be a complex code in accordance with one or more standards in this or other applications. For example, said standards are used for communicating information such as the name of the consignor, the number of pages of a document (possibly converted into weight, for example by the marking module), a serial number of a document, a desired service degree, a franking value, a date, etc, to the outside world.

In addition to the information as indicated above, the marks M1, M2, M3 may contain signs for a reading system 7, such as a start bit, a parity bit and a stop bit.

Although the subject matter has been described in language specific to an environment, structural features and/or methodological acts, it is to be understood that the subject matter defined in the appended claims is not limited to the environment, specific features or acts described above as has been held by the courts. Rather, the environment, specific features and acts described above are disclosed as example forms of implementing the claims.

What is claimed is:

1. A method for printing at least one document provided with information content and with at least one mark on at least one printing unit, the method comprising the steps of:
providing and/or receiving at least a first print instruction comprising the information content to be printed on the document from a document generator;
generating at least a second print instruction for printing said at least one mark on the document; and
processing the first and the second print instruction for printing the information content and the mark on the document, wherein generating and processing of the second print instruction for printing said at least one mark takes place independently of the information content of the first print instruction.

2. The method according to claim 1 wherein generating includes generating the second print instruction so as to print with marks comprising an uninterrupted series of sequence information; and wherein processing includes printing of at least a first and a second document intended for different follow-up treatments, wherein the sequence information from the first to a second document forms a continuous series.

3. The method according to claim 2, wherein at least the first document or the second document comprises more than one sheet, and wherein printing includes printing said series consecutively on the sheets of the first and the second document.

4. The method according to claim 3, wherein the sheets of the document comprising more than one sheet, in addition to generating the second print instruction for printing a mark comprising sequence information, further comprises providing at least a first pre-printed mark or a second pre-printed mark different from said first mark.

5. The method according to claim 2, wherein the mark is a mark in the form of a bar code or a bit code.

6. The method according to claim 1 wherein generating the second print instruction is in response to an auxiliary signal for printing at least a first or a second sheet of the document, for printing at least a first mark for the first sheet and/or a second mark, different from the first mark, for the second sheet; and wherein processing includes printing of the first mark on the first sheet or the second mark on the second sheet of the document.

7. The method according to claim 6, wherein a printing unit for printing comprises at least a first feeding station for first or last sheets of the document and a second feeding station for second sheets of the document, and wherein generating the second print instruction is when a sheet is taken from the first feeding station or the second feeding station on the basis of said auxiliary signal; and wherein printing comprises printing of at least the first mark and the second mark on a first sheet or the last sheet respectively a second sheet.

8. The method according to claim 6, wherein the printing unit comprises at least a first feeding station for first or last sheets of the document and a second feeding station for second sheets of the document, and wherein generating said second print instruction is when a sheet is taken from the first feeding station or the second feeding station on the basis of said auxiliary signal; and wherein printing comprises printing of at least the first mark and the second mark on a sheet preceding said first sheet or a sheet following the last sheet respectively a second sheet.

9. The method according to claim 8, wherein the first print instruction, in addition to the information content to be printed, comprises the auxiliary signal for selecting said at least first or second feeding station.

10. The method according to claim 7, wherein the first print instruction, in addition to the information content to be printed, comprises the auxiliary signal for selecting said at least first or second feeding station.

11. The method according to claim 6, wherein the printing unit comprises a single feeding station for first and second sheets of the document to be printed, and wherein printing comprises printing at least the first mark and the second mark on a first sheet and a second sheet, respectively, on the basis of a virtual auxiliary signal.

12. The method according to claim 1, wherein printing comprises printing an overlay for at least one mark on the document.

13. The method according to claim 1, wherein generating the second print instruction comprises generating the second print instruction with one or more marks comprising logistic information for the distribution of the documents; and wherein printing comprising printing one or more of said marks on the first sheet of the documents.

14. A printing unit for printing at least one document provided with information content and at least one mark, which mark is arranged for follow-up treatment of the document, wherein the printing unit is arranged for receiving a first print instruction comprising the information content to be printed on the document, the printing unit comprising:
a marking module arranged for generating at least a second print instruction for printing at least one mark on the document independently of the information content of the first print instruction and wherein the printing unit, in use, prints the information content and the mark on the document.

15. The printing unit according to claim 14, wherein the marking module is configured for generating the second print instruction so as to print with marks comprising an uninterrupted series of sequence information.

16. The printing unit according to claim 14, wherein the marking module comprises software code portions for generating said at least a second print instruction for printing at least one mark on the document independently of the information content of the first print instruction

17. The printing unit according to claim 14 wherein the marking module comprises a physical module.

18. A system for printing at least one document provided with information content and at least one mark, which mark is arranged for follow-up treatment of the document, the system comprising:
a document generator configured for providing at least a first print instruction comprising the information content to be printed on the document;
a marking module arranged for generating at least a second print instruction for printing at least one mark on the document; and
a printing unit configured for processing the first and the second print instruction for printing the information content and the mark on the document, wherein the system is arranged for generating and processing the second print instruction for printing the mark independently of the information content of the first print instruction.

19. A marking module for generating a second print instruction for printing at least one mark on a document, wherein the marking module is arranged for co-operating with at least one document generator and/or a printing unit for providing and processing, respectively, a first print instruction comprising information content to be printed on the document and for printing the information content and the mark, said marking module further being arranged for generating the second print instruction independently of the information content of the first print instruction.

20. The marking module according to claim 19 and further being configured for generating the second print instruction so as to print with marks comprising an uninterrupted series of sequence information.
